(19) United States
(12) Patent Application Publication
(10) Pub. No.: US 2019/0338099 A1
(43) Pub. Date: Nov. 7, 2019

(54) THREE-DIMENSIONAL SUCTION MOLDING METHOD FOR POLYMERIC FOAMS

(71) Applicant: Trexel, Inc., Wilmington, MA (US)

(72) Inventor: Samuel Edward Dix, Newton, NH (US)

(73) Assignee: Trexel, Inc., Wilmington, MA (US)

(21) Appl. No.: 15/972,463

(22) Filed: May 7, 2018

(51) Int. Cl. C08J 9/12; C08J 9/00

(52) U.S. Cl. CPC C08J 9/122; C08J 9/0085; C08J 9/0019; B29C 47/0071; B29C 47/1072; C08J 2377/00; C08J 2203/06; C08J 2205/044; C08J 2323/06; C08J 2323/12; C08J 2327/16; C08J 2201/03

(57) ABSTRACT

Three-dimensional (3D) suction molding methods and related polymeric foam articles are described. The methods may be used in discontinuous plastication processes.

### FIELD

The present invention relates generally to polymeric foams and, more particularly, to a three-dimensional (3D) suction molding method to form polymeric foam articles.

### BACKGROUND

Polymeric foams include a plurality of voids, also called cells, in a polymer matrix. Foams may have a number of advantages including materials (and related cost) savings resulting from the presence of the voids.

Polymeric materials may be processed using a variety of techniques. Many techniques employ an extruder which plasticates polymeric material by the rotation of a processing screw within a barrel. Some processing techniques, such as injection molding or suction molding, are discontinuous. That is, during operation, the screw does not plasticate polymeric material continuously throughout the molding cycle. For example, the screw may stop rotating and, thus, cease to plasticate polymeric material after a sufficient amount of polymeric material mixed with blowing agent (also referred to as a “shot”) is accumulated (e.g., downstream of the screw in the barrel and/or in an accumulator separate from the extruder).

Three-dimensional (3D) suction molding is a polymer processing technique that involves production of 3D molded articles. In this context, the term “three-dimensional (3D)” refers to articles that have dimensions that vary along all three axes. 3D molded articles generally are tubular, relatively long and may be formed without mold lines (e.g., no flash on the line of the mold closure) that are associated with typical blow molding processes. Pipes are a common example of 3D suction molded articles.

It would be advantageous to produce 3D suction molded articles out of polymeric foam materials.

### SUMMARY OF INVENTION

Three-dimensional (3D) suction molding methods and related polymeric foam articles are described herein.

In one aspect, a 3D suction molding method is provided. The method comprises conveying polymeric material in a downstream direction in an extruder including a screw configured to rotate in a barrel during a plastication period of a suction molding cycle. The method further comprises introducing blowing agent into the polymeric material to form a mixture of polymeric material and blowing agent in the extruder. The blowing agent is introduced into the polymeric material during only a portion of the plastication period. The method further comprises accumulating a shot of the mixture in an accumulation volume and moving a piston to inject the shot through an outlet to form a parison in a cavity defined between walls of a 3D mold. The method further comprises applying a vacuum to pull the parison through the mold cavity. The method further comprises blowing the parison out against the walls of the mold and opening the mold to recover a 3D suction molded polymeric foam article.

In some embodiments, the blowing agent is nitrogen.

The weight percentage of blowing agent, in some embodiments, is less than 0.1 weight percent based on the weight of the polymeric material. For example, the weight percentage of blowing agent may be between 0.010 and 0.030 weight percent based on the weight of the polymeric material.

In some embodiments, the plastication period lasts for a time period and blowing agent is introduced for a time less than 50% of the time period; or, in some embodiments, less than than 30% of the time period. The plastication period may last for a time period and blowing agent may be introduced within the first quarter of the time period. In some embodiments, the plastication period lasts for a time that is at least 50% of the time period of the suction molding cycle.

In some embodiments, the blowing agent is not introduced in the polymeric material during a portion of the plastication period and during an injection period of the suction molding cycle.

In some embodiments, the blowing agent may be introduced into the polymeric material at a pressure that is within 25% of the pressure of the polymeric material in the extruder at the point of blowing agent injection.

In some embodiments, the polymeric material is selected from the group consisting of nylon, polyethylene, polypropylene and polyvinylidene fluoride. The polymeric material may include an additive selected from the group consisting of glass fiber, talc, PTFE, CaCO₃ and graphene.

In some embodiments, the foam article has an average cell size of between 10 and 200 microns. The foam article may be cylindrical. In some embodiments, the foam article has a diameter between 20 mm and 120 mm and/or a wall thickness between 0.5 mm and 5 mm. In some embodiments, the foam article has a density reduction between 5 weight % and 60 weight %.

Other aspects, embodiments and features will become apparent from the following non-limiting detailed description when considered in conjunction with the accompanying drawings, which are schematic and which are not intended to be drawn to scale. In the figures, each identical or nearly identical component that is illustrated in various figures typically is represented by a single numeral. For purposes of clarity, not every component is labeled in every figure, nor is every component of each embodiment shown where illustration is not necessary to allow those of ordinary skill in the art to understand the invention. In cases where the present specification and a document incorporated by reference include conflicting disclosure, the present specification shall control.

### BRIEF DESCRIPTION OF DRAWINGS

FIG. 1 illustrates an embodiment of a system that may be used in connection with 3D suction molding methods described herein.

### DETAILED DESCRIPTION

Three-dimensional (3D) suction molding methods and related polymeric foam articles are described herein. The methods may be used in discontinuous plastication processes that include a plastication period (e.g., when the screw rotates in an extruder) and a period in which polymeric material is not plasticated (e.g., when the screw does not rotate in the extruder). As described further below, the methods may involve controlling blowing agent flow so that blowing agent is introduced into polymeric material in the extruder only during a portion of the plastication period of the molding cycle (e.g., and not during other times of the molding cycle). Such control over blowing agent introduction may have several advantages including improved process control and stability, as well as enabling use a conventional processing screw (e.g., in contrast to a specialized processing screw used in certain microcellular foam processes). The methods can be used to produce 3D suction molded foam articles that may be used in a variety of applications such as pipes and ducts.

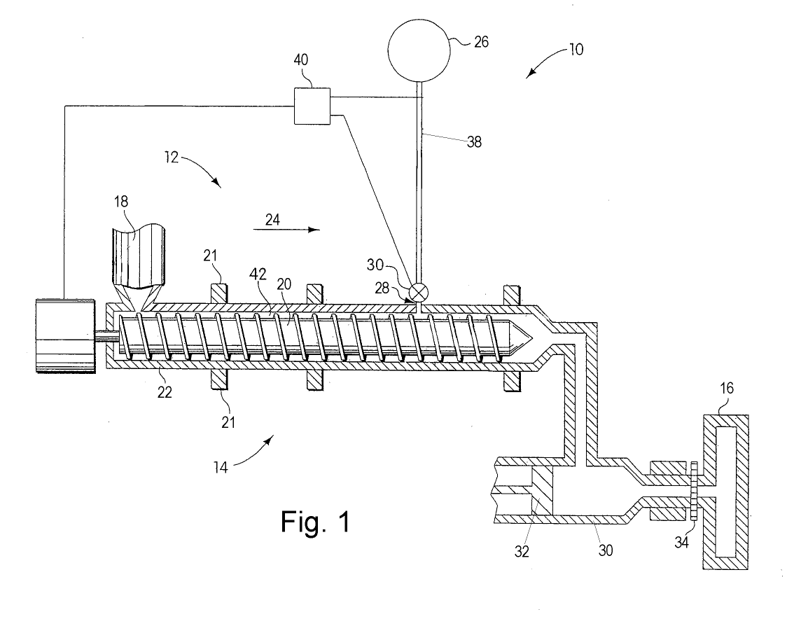

Referring to FIG. 1, a blowing agent introduction system 10 is used to deliver blowing agent to a polymer processing system 12. In this embodiment, system 12 is a discontinuous polymer processing system that includes an extruder 14 and a 3D suction mold 16. As described further below, the system operates to produce a 3D suction molded foam article in a molding cycle which can be repeated to produce additional articles.

As shown, a hopper 18 provides polymeric material (e.g., in the form of pellets) to the extruder. The extruder includes a screw 20 designed to rotate within a barrel 22 to plasticate polymeric material during a plastication period of a molding cycle. It should be understood that the plastication period coincides with the time during which the screw is rotating to plasticate polymeric material. That is, the plastication period lasts for a time period that begins with the onset of screw rotation and lasts until the screw stops rotating in any given molding cycle.

Heat (e.g., provided by heaters on the extruder barrel) and shear forces (e.g., provided by the rotating screw) act to melt the polymeric material to form a fluid polymeric stream which is conveyed in a downstream direction 24 by rotation of the screw. In the illustrated embodiment, the blowing agent introduction system includes a physical blowing agent source 26 that is connected to one or more port(s) 28 in the barrel of the extruder. The system is configured to control the flow of physical blowing agent from the source into the fluid polymeric stream in the extruder. As described further below, blowing agent flow is controlled such that blowing agent is introduced into polymeric material in the extruder only during a portion of the plastication period of the molding cycle. When blowing agent is introduced into the fluid polymeric stream, a mixture is formed that is conveyed downstream in the extruder barrel. In some embodiments, the mixture is a single-phase solution with the physical blowing agent being dissolved in the polymeric material prior to injection into the mold.

In the illustrated embodiment, an accumulator 30 is arranged between the outlet of the extruder and the inlet of the mold. The mixture may be supplied to the accumulator from the extruder until a desired condition has been reached (e.g., after a predetermined time period, at a predetermined piston position in the accumulator, after a predetermined amount (e.g., mass) of shot is accumulated) at which point the screw may stop rotating so that polymeric material (and the mixture of polymeric material and blowing agent) is no longer conveyed in the extruder and supplied to the accumulator.

A moveable piston 32 is positioned within the accumulator and an optional valve 34 may be arranged between the accumulator and the mold. The piston provides back pressure to prevent any premature foaming as the mixture is accumulated with the valve being in a closed configuration. Once the desired condition has been reached, the piston moves forward to inject the shot through an outlet 36 of the mold with the valve being in an open configuration. A die (also referred to as a mold bushing) (not shown) may be present at the mold outlet through which the mixture is injected. The die may be movable to control dimensions of the subsequently formed parison.

It should be understood that not all embodiments include an accumulator external of the extruder as shown. In some embodiments, the mixture of polymeric material and blowing agent is accumulated in a region within the barrel downstream of the screw. In such embodiments, the accumulating mixture may push the screw in an upstream direction within the barrel as it rotates. When a desired condition is reached (e.g., after a predetermined time period, at a predetermined screw position in the barrel, after a predetermined amount (e.g., mass) of shot is accumulated), the screw stops rotating and polymeric material (and the mixture of polymeric material and blowing agent) is no longer conveyed in the extruder. In such embodiments, the screw then may move in a downward direction within the barrel to inject the shot into the mold.

It also should be understood that the systems may not include a valve separate from the die (mold bushing). In some cases, the two components may be combined.

In the illustrated embodiment, the mixture is subjected to a pressure drop during injection which nucleates a large number of cells in a polymeric matrix. The injected mixture initially is in the form of a tube-shaped parison in a cavity 36 of the 3D mold. In some embodiments, lubrication may be sprayed into the inlet of the closed mold and then a vacuum is applied (e.g., to first create a plugged hole) and then to pull the parison through the mold cavity. Air is introduced into the parison (e.g., through a hold formed in the top) to push the parison against walls of the mold. The parison cools (e.g., on inside from air and on outside from mold) and solidifies to form a foam article including a plurality of cells formed within a polymer matrix. The mold may be opened and the 3D suction molded polymeric foam article may be recovered.

The molding cycle may be repeated to produce additional foam articles. In such cases, the screw begins to rotate once again to begin another plastication period as described above. It should be understood that the time period after the plastication period of a molding cycle is referred to herein as the “injection period” of the molding cycle. That is, a molding cycle includes a plastication period followed by an injection period. As used herein, molding cycle time is used as generally known in the art and refers to the total time from removal of a first molded article from the mold to removal of a second molded article from the mold produced in a successive molding step. In some embodiments, the plastication period lasts for a time that is at least 50% of the suction molding cycle time; in some embodiments, at least 75% of the suction molding cycle time; and, in some embodiments, at least 95% of the suction molding cycle time.

The blowing agent introduction system includes an upstream end connectable to source 26 and a downstream end connectable to port(s) 28. Conduit 38 extends from the upstream end to the downstream end to connect various components of the introduction system and to provide a pathway from the source to the blowing agent port. The components may include one or more pump(s), pressure regulator(s), pressure measuring device(s), temperature measuring device(s), valve(s) and accumulator(s), amongst other types of components. As described further below, the blowing agent introduction system may be configured to selectively control the flow of blowing agent to the extruder. Suitable configurations have been described in commonly-owned U.S. Pat. Nos. 9,108,350, 6,926,507 and 6,616,434 all of which are incorporated herein by reference in their entireties. In some embodiments, the blowing agent introduction systems may include a valve (e.g., ball check valve) in the vicinity of the blowing agent port(s) which is configured to open and close (e.g., in response to a signal from a controller) to selectively control the introduction of blowing agent into the extruder. In some embodiments, such a valve may be used to prevent back flow of polymeric material out of the extruder.

The system may include a control system 40 which is connected to various components of the polymer processing system and/or blowing agent introduction system. For example, the control system may operate to selectively control the flow of blowing agent to the extruder. The control system may be any of the type known in the art such as a computer. In some embodiments, the control system is configured receiving input signals from components of the system(s) (e.g., pressure measuring devices, temperature measuring devices, input signals relating to screw position and rotation, etc.) and sending appropriate output signals to components of the system(s) (e.g., valves, pressure regulators, etc.). In some embodiments, input signals may be received by the controller continuously and output signals may be sent by the controller continuously and simultaneously (e.g., within real time). In other cases, the input signals and the output signals may be respectively received and sent continuously. The rate at which the input signals are received need not match the rate at which the output signals are sent. For example, the input signals may be received continuously, while the output signals may be provided at an interval.

The systems and methods may control the flow of blowing agent such that blowing agent introduction into polymeric material in the extruder is permitted during desired time periods and prevented during other time periods. For example, blowing agent flow may be controlled to permit blowing agent introduction into the polymeric material during only a portion of the plastication period and prevented during other times during the plastication period and other times during the molding cycle (e.g., injection period).

In some embodiments, the blowing agent is introduced into the polymeric material during the plastication period for a time lasting less than 50% of the time of the plastication period. In some embodiments, the blowing agent is introduced into the polymeric material during the plastication period for a time lasting less than 30% of the time of the plastication period. The blowing agent may be introduced into the polymeric material during a time during the plastication period for greater than 5%, or 10%, of the time of the plastication period.

In some embodiments, the blowing agent is introduced into the polymeric material for a time lasting at least 5 seconds, at least 10 seconds and/or at least 20 seconds. In some cases, the blowing agent is introduced into the polymeric material for a time lasting at most 40 seconds, at most 30 seconds and/or at most 25 seconds. It should be understood that the time may be defined by any of the upper and lower ranges describes above. For example, the blowing agent may be introduced into the polymeric material for a time lasting at least 5 seconds and at most 30 seconds.

In some embodiments, the blowing agent is introduced into the polymeric material for a time that is at or near the beginning of the plastication period. For example, the blowing agent is introduced into the polymeric material for a time that is entirely within the first half of the plastication period. In some embodiments, the blowing agent is introduced into the polymeric material for a time that is entirely within the first quarter of the time period. In some cases, the blowing agent may be introduced at least 3 seconds, at least 5 seconds and/or at least 10 seconds after the start of the plastication period.

Introducing blowing agent during selected time periods, as described above, can lead to a number of advantages including improved process control and stability. For example, such introduction can lead to formation of a solid (i.e., without blowing agent), more viscous section of the polymer melt when blowing agent is not introduced. Such a solid section, for example when produced at a time at the end of the plastication period and during the injection period, may be present proximate the blowing agent port. If the solid section is not present, in some cases, blowing agent introduced through the port and not yet dissolved in the polymer melt may have the tendency of being pushed upstream in the barrel (and, in some cases, through the hopper) which can lead to process instabilities (e.g., in some cases, process may need to be stopped).

Control over blowing agent introduction, as described above, can also simplify the equipment used in the process. For example, a conventional polymer processing screw may be used as opposed to a specialized screw (e.g., including a restriction element and/or wiping section and/or specialized mixing section) used in certain processes to produce microcellular polymeric foam materials. Such simplification can result in equipment cost savings.

In some embodiments, it may be advantageous for blowing agent to be introduced into the polymer material at a pressure that is similar to that of the polymeric material (e.g., when the polymeric material has a relatively low melt strength) in the extruder. For example, the blowing agent may be introduced into the polymeric material at a pressure that is within 25% and/or within 10% of the pressure of the polymeric material in the extruder at the point of blowing agent injection. Blowing agent pressure at introduction may be controlled, in some embodiments, using a pressure regulator or other means.

The blowing agent source may supply to the introduction system any type of physical blowing agent known to those of ordinary skill in the art including nitrogen, carbon dioxide, hydrocarbons, chlorofluorocarbons, noble gases and the like or mixtures thereof. The blowing agent may be supplied in any flowable physical state such as a gas, a liquid, or a supercritical fluid. In some embodiments, it may be preferable to use nitrogen as a preferred blowing agent.

The blowing agent introduction system may be used to introduce blowing agent into polymeric material within the extruder over a wide range of different flow rates as required by the particular process. The blowing agent is typically introduced into the polymeric material so as to provide the mixture with a desired blowing agent level. The desired blowing agent amount depends upon the particular process and blowing agent used. Generally, the amount of blowing agent is less than about 10% by weight based on the total weight of polymeric material. In many embodiments, the blowing agent level is less than about 5%, in others, less than about 3%, and, in others, less than about 1% based on the total weight of polymeric material. In particular, when nitrogen is used as the blowing agent, the amount of nitrogen may be less than 0.1 weight percent based on the weight of the polymeric material (e.g., between 0.01 and 0.03 weight percent based on the weight of the polymeric material). In some embodiments, the blowing agent is present in an amount greater than 0.01 weight percent based on the weight of the polymeric material.

In general, any type of suitable polymeric material may be processed using the systems and methods described herein. For example, polymeric materials that are well suited to be used in suction blow molding processes may be used. Suitable polymeric materials include nylon, polyethylene (e.g., LDPE, HDPE), polypropylene and polyvinylidene fluoride (PVDF), amongst others. In some embodiments, nylon may be preferred. In some embodiments, the polymeric material may have a relatively low melt strength when processed in the extruder. In some embodiments, the polymeric material is not an olefin. The polymeric material may include one or more conventional additives. For example, the polymeric material may include one or more of glass fiber, talc, PTFE, CaCO₃ and graphene.

As noted above, the systems and methods are used to produce polymeric foam materials. In some embodiments, the foam materials may have a small cell size. For example, the materials may be microcellular polymeric foam materials. In some embodiments, the foam materials may have an average cell size of less than 200 microns; and, in some embodiments, the foam materials may have an average cell size of less than 100 microns. It should be understood that polymeric foam materials having larger cell sizes may also be formed using the systems and methods described herein.

The polymeric foam materials may be produced at a variety of different densities. For example, the polymeric foam materials may have a density reduction of at least 10% compared to solid polymer; in some embodiments, at least 20%; in some embodiments at least 30%; and, in some embodiments, at least 50%. The polymeric foam materials may have a density reduction of less than 70%; and, in some embodiments, less than 50%. It should be understood that the density reductions between any of the above-noted ranges (e.g., less than 70% and at least 30%) are possible.

The 3D suction molded foam articles can have a variety of characteristics. In some embodiments, the articles may be relatively long. For example, the articles may have a length (as measured from one end to the other end) of at least 24 inches; and, in some embodiments, a length of at least 36 inches (e.g., between 36-48 inches). As noted above, the articles may be tubular in shape. In such embodiments, the diameter of the tube-shaped articles may be between 20 mm and 120 mm; and, in some cases, between 40 mm and 80 mm. In some embodiments, the wall thickness of the tube-shaped article may be between 0.5 mm and 5 mm; and, in some cases, between 1 mm and 3 mm. The articles may have dimensions that vary along all three axes. In some cases, the articles have three different primary axis (i.e., the axis of primary extent) at different sections of the articles.

Advantageously, the 3D suction blow molded articles may be produced may be formed without mold lines that are associated with typical blow molding processes. For example, the articles may not have any flash on a line of the mold closure. The articles may be used in a variety of applications such as pipes and ducts.

What is claimed is:

1. A 3D suction molding method comprising:
conveying polymeric material in a downstream direction in an extruder including a screw configured to rotate in a barrel during a plastication period of a suction molding cycle;
introducing blowing agent into the polymeric material to form a mixture of polymeric material and blowing agent in the extruder, wherein the blowing agent is introduced into the polymeric material during only a portion of the plastication period;
accumulating a shot of the mixture in an accumulation volume;
moving a piston to inject the shot through an outlet to form a parison in a cavity defined between walls of a 3D mold;
applying a vacuum to pull the parison through the mold cavity;
blowing the parison out against the walls of the mold; and
opening the mold to recover a 3D suction molded polymeric foam article.

2. The method of claim 1, wherein the blowing agent is nitrogen.

3. The method of claim 1, wherein the weight percentage of blowing agent is less than 0.1 weight percent based on the weight of the polymeric material.

4. The method of claim 1, wherein the weight percentage of blowing agent is between 0.010 and 0.030 weight percent based on the weight of the polymeric material.

5. The method of claim 1, wherein the plastication period lasts for a time period and blowing agent is introduced for a time less than 50% of the time period.

6. The method of claim 1, wherein the plastication period lasts for a time period and blowing agent is introduced for a time less than 30% of the time period.

7. The method of claim 6, wherein the plastication period lasts for a time period and blowing agent is introduced within the first quarter of the time period.

8. The method of claim 1, wherein the plastication period lasts for a time that is at least 50% of the time period of the suction molding cycle.

9. The method of claim 1, wherein the blowing agent is introduced into the polymeric material at a pressure that is within 25% of the pressure of the polymeric material in the extruder at the point of blowing agent injection.

10. The method of claim 1, wherein the polymeric material is selected from the group consisting of nylon, polyethylene, polypropylene and polyvinylidene fluoride.

11. The method of claim 1, wherein the polymeric material includes an additive selected from the group consisting of glass fiber, talc, PTFE, CaCO₃ and graphene.

12. The method of claim 1, wherein the foam article has an average cell size of between 10 and 200 microns.

13. The method of claim 1, wherein the foam article is cylindrical.

14. The method of claim 13, wherein the foam article has a diameter between 20 mm and 120 mm.

15. The method of claim 1, wherein the foam article has a wall thickness between 0.5 mm and 5 mm.

16. The method of claim 1, wherein the foam article has a density reduction between 5 weight % and 60 weight %.

17. The method of claim 1, wherein the blowing agent is not introduced in the polymeric material during a portion of the plastication period and during an injection period of the suction molding cycle.
